(19) United States
(12) Patent Application Publication
(10) Pub. No.: US 2002/0099932 A1
(43) Pub. Date: Jul. 25, 2002

(54) Mirroring processor stack

(76) Inventor: Manuel R. Muro JR., Chandler, AZ (US)

Correspondence Address: Ronald L. Chichester, Baker Botts L.L.P., One Shell Plaza, 910 Louisiana Street, Houston, TX, 77002-4995, US

(21) Appl. No.: 09/769,681

(22) Filed: Jan. 25, 2001

(51) Int. Cl. G06F 9/312

(52) U.S. Cl. 712/228

(57) ABSTRACT

An improved computer processor architecture in the form of an apparatus with a mirrored stack and method of using the same are provided that enable increased functionality for a plurality of processor events. The architecture removes from software the burden of preserving and maintaining the processor registers upon certain processor events, thereby improving coding efficiency and the utilization of processor time. Finally, the architecture provides a mechanism for speeding up CALL and RETURN instruction execution times and for other instances where processor register must be preserved to prevent loss or corruption.

### CROSS REFERENCE TO RELATED PATENT APPLICATION

This application is related to pending U.S. Patent Application Serial No. [MTI-1541] filed on ______ , entitled “HARDWARE ARCHITECTURE FOR FAST SERVICING OF PROCESSOR INTERRUPTS” in the name of Manuel R. Muro, Jr. and Timothy J. Phoenix, that is assigned to the same assignee as the present application.

### BACKGROUND OF THE INVENTION

1. Field of the Invention

The present application is related to microprocessors. More specifically, the present application is related to a microprocessor architecture that tracks the values stored in a selected register.

2. Description of the Related Technology

Digital electronics has become an integral part of all types of products purchased by the consumer, business and industry. These products may comprise alarm systems, remote monitoring and control systems, portable electronic devices such as computers, cellular telephones, personal digital assistants (PDA), portable global positioning satellite (GPS) terminals, and the like.

The use of microprocessors has proliferated in recent years partly due to the ability of designers of such to produce flexible, easy-to-use systems. Moreover, microprocessors are usable for both traditional data processing environments and as replacements for random logic systems. With the proliferation of devices, it has become desirable to provide more flexible and easy to use microprocessors to aid system designers in incorporating the devices into larger systems. High data rates are also desirable in some applications, and increased throughput, with easy-to-use devices is a continuing design goal. One way to achieve high data rates is to operate on larger pieces of data in parallel.

Digital computer memory contains cells, which may be referred to by addresses. The address of a memory cell is sometimes referred to as a pointer, since it may be thought of as pointing to the memory cell to which it refers. Pointers may occur at the level of machine language both as direct addresses and as indirect addresses. Pointers may also be encountered in mid-level languages such as C and high level languages such as PASCAL. In general, pointers may be used to connect individual memory cells and also to point from one composite data structure to another. Pointers are essential in any composite data structure for linking components of the data structure.

Most digital processors employ one or more stacks. A stack is a linear list of memory locations for which all insertions and deletions, and usually all access, are made at one end of the list. The properties of a simple stack may be illustrated by a railroad switching network having a track into which railroad cars may be inserted and removed from only one end. At any given time, only the most recently entered railroad car may be removed from the track. Railroad cars are said to enter and leave the track in a last-in-first-out (LIFO) order. Alternatively, a stack may be defined as a linear list whose elements may be created and deleted only in a last-in-first-out order. Stacks arise in computational programming dealing with structures whose components are nested. See, e.g., Anthony Ralston and Edward D. Reilly, “ENCYCLOPEDIA OF COMPUTER SCIENCE, Third Edition (1993, Van Nostrand Reinhold) ISBN 0-442-27679-6.

U.S. Pat. No. 5,241,679, to Nakagawa et al., discloses a data processor that employs a dedicated stack memory device for each register. Nakagawa discloses that the contents of all the registers may be saved substantially simultaneously to the stack memory devices instead of sequentially one by one to a external memory device or high-speed buffer memory. Nakagawa also discloses that the contents of all the dedicated stack memories may be restored simultaneously to the associated registers. Nakagawa further discloses that it is possible to select registers for which saving and restoring is not to be performed.

The prior art, however, does not provide, however, an optimized stack memory that can be mirrored to provide additional functionality. There is, therefore, a need in the art for a memory stack that can be mirrored to provide quick referencing if the original stack is corrupted, disabled, or otherwise modified.

### SUMMARY OF THE INVENTION

The present invention solves the problems inherent in the prior art by providing an apparatus, system and method for mirroring a memory stack to enable quick referencing of the contents of the stack. The present invention provides one or more mirror stacks (“M-stacks”) that are, individually, tied to any number of critical registers—one M-stack per critical register. The critical register can be a standard register, or a memory location that is used akin to a register. Any writes to the specific critical register are also written to the location pointed to by the M-stack's pointer. The interface between the critical register and the M-stack is isolated from other busses so that a transfer of data can take place between the M-stack and the critical register simultaneously and independently from other busses (either M-stack or common). Finally, the uniqueness of the M-stack requires the introduction of a new stack operation: “HOLD.” In a prior art stack, the stack pointer gets adjusted during both “read” and “write” operations. In contrast, the pointer for an M-stack is adjusted only during “read” and “hold” operations. During “write” operations to the M-stack, the M-stack pointer is not adjusted.

Other and further objects, features and advantages will be apparent from the following description of presently preferred embodiments of the invention, given for the purpose of disclosure and taken in conjunction with the accompanying drawings.

### BRIEF DESCRIPTION OF THE DRAWINGS

FIG. 1 is a schematic illustration of the register interface with the mirror stack of the present invention;

FIG. 2 is a flow diagram illustrating the status of the mirror stack of the present invention during various operations; and

FIG. 3 is a timing diagram of the mirror stack of the present invention.

### DETAILED DESCRIPTION OF THE PREFERRED EMBODIMENTS

The present invention is a microprocessor architecture that supports a central processing unit that executes instructions and, as a consequence, manipulates information in a memory stack.

In order to realize the architecture of the present invention, the difference between a conventional stack and a “mirrored stack” must be understood. A “mirroring” stack is a very specialized application of a stack. The mirroring stack is associated with a specific memory location or register for which the mirroring stack is intended to track (or mirror) its value. Because the mirror stack is always monitoring the value of the memory location/register, only the mirror stack's pointer needs to be adjusted when the value must be restored after a desired event.

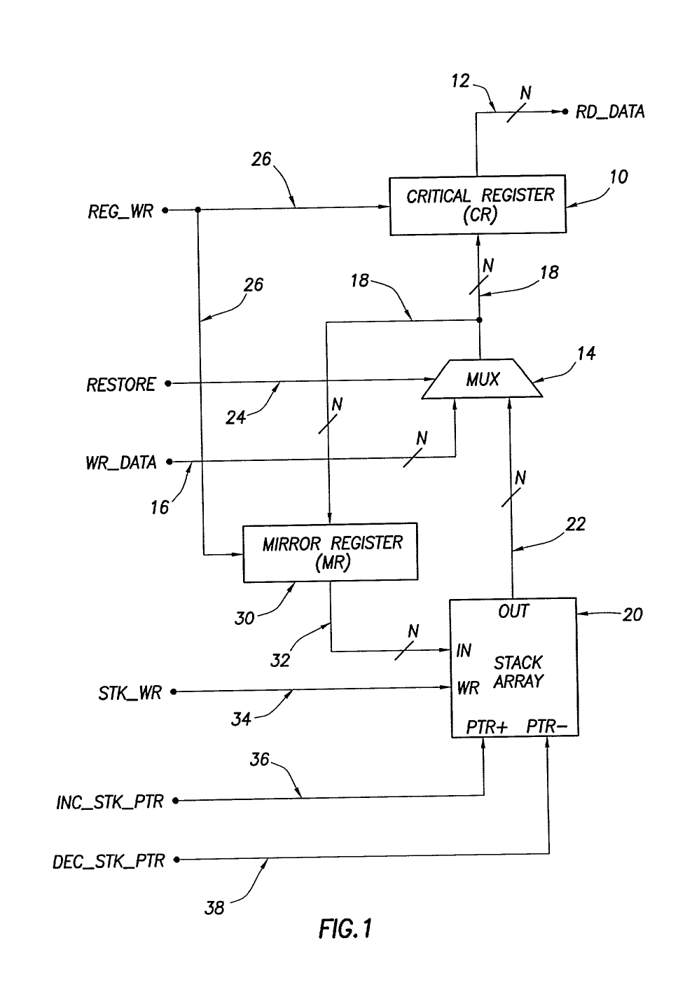

For example, FIG. 1 shows a block diagram of the mirror stack configuration that is tied to a specific register that has been designated as a critical register. The critical register 10 may be any register or memory location for which it is desirable to return the value in that register or memory location to the state or value that it contained just before the invocation of the desired event. Examples of critical registers 10 include program counters (PC), status registers (SR), and any other register that may be modified during the execution of a software program. As shown in FIG. 1, critical register 10 is connected to a read bus, illustratively labeled as RD_DATA 12 which is operable to transmit data from critical register 10 to a common bus, control logic or other component. Critical register 10 is operable to receive a control signal, illustratively labeled “REG_WR” 26. Critical register 10 is also connected to a bus 18. Bus 18 is the output of a multiplexor, or mux, 14. Data will be written from bus 18 to critical register 10 and to the mirror register 30 if the REG_WR control signal 26 is asserted. The present invention is not limited to the specific configuration depicted in FIG. 1. For example, the present invention may be utilized in a system that contains several critical registers. If there are several critical registers 10, a separate REG_WR control signal 26 will be associated with each critical register 10. Depending upon the implementation, the stack array pointer may also be shared in order to provide increased functionality.

The multiplexer (“mux”) 14 may be any communications device suitable for multiplexing or combining several signals for transmission over a single signal line. Mux 14 is connected to a write bus, illustratively labeled “WR_DATA” 16, a RESTORE control signal 24 and bus 22. Write bus 16 is operable to transmit data from a common bus, control logic or other source. Note that in the configuration shown in FIG. 1, critical register 10 is not directly coupled to the write bus 16. Critical register 10 is preferably isolated from any common bus. Bus 22 is coupled to the out port of stack array 20 and is operable to transmit the output from stack array 20.

Stack array 20 may be any register or data structure in which items are removed, or popped, in the reverse order from which they were added, or pushed, so that the most recently added items are the first to be removed. Stack array 20 is typically a linear list of memory locations. Stack array 20 will be the source of the information or memory locations the processor uses for its write to or restore from operations. Stack array 20 is operable to receive a INC_STK_PTR control signal 36 via its ptr+ input port and a DEC_STK_PTR control signal 38 via its ptr− input port. The INC_STK_PTR control signal 36 increments the stack pointer associated with stack array 20 while the DEC_STK_PTR control signal 38 decrements the stack pointer. The wr port of stack array 20 is operable to receive a STK_WR control signal 34. In systems that contain several stack arrays 20, STK_WR is a common signal throughout all the stack arrays 20 to be written. Similarly, INC_STK_PTR 36 and DEC_STK_PTR 38 may also be common or connected to all stack arrays 20. Preferably, the RD_DATA bus 12 is not coupled to stack array 20. If the RD_DATA bus 12 was coupled to stack array 20, the loading burden on critical register 10 and stack array 20 would be increased and accordingly result in decreased performance and is an additional distinction of the present invention over the prior art.

A mirror register or mirror stack memory 30 is connected to the write bus 16 via the output bus 18 of mux 14. Thus, both critical register 10 and mirror register 30 are operable to receive data from write bus 16 via mux 14 through bus 18. Both critical register 10 and mirror register 30 are operable to receive a REG_WR control signal via signal line 26. As a result, the assertion of the REG_WR control signal is simultaneously driven to both critical register 10 and mirror register 30. Therefore, any data that is written to critical register 10 will be written to mirror register 30. In this sense, mirror register 30 is associated with critical register 10. Bus 32 carries data from mirror register 30 to the in port of stack array 20. The size of bus 32 as well as read bus 12, write bus 16, bus 18, and bus 22 is designated by the letter “N.” N is equal to the size, in bits, of critical register 10. As discussed above, the present invention may be implemented in a system containing several critical registers 10 and several stack arrays 20. In this case, a mirror register 30 will be associated with each critical register 10 and stack array 20.

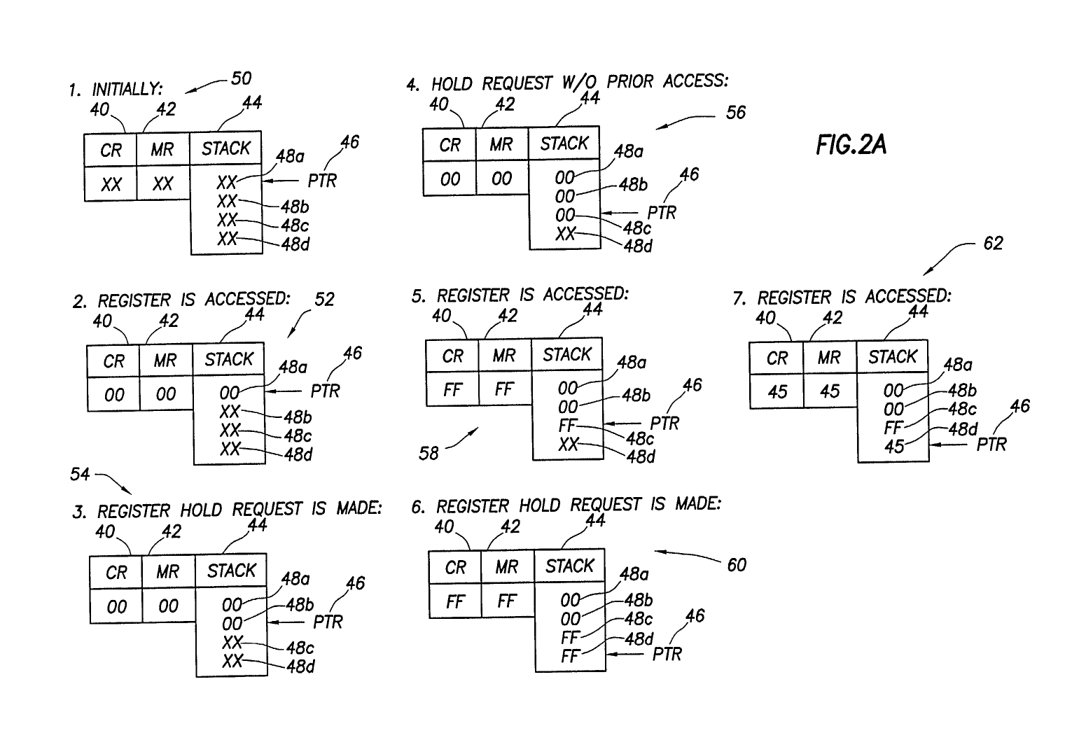

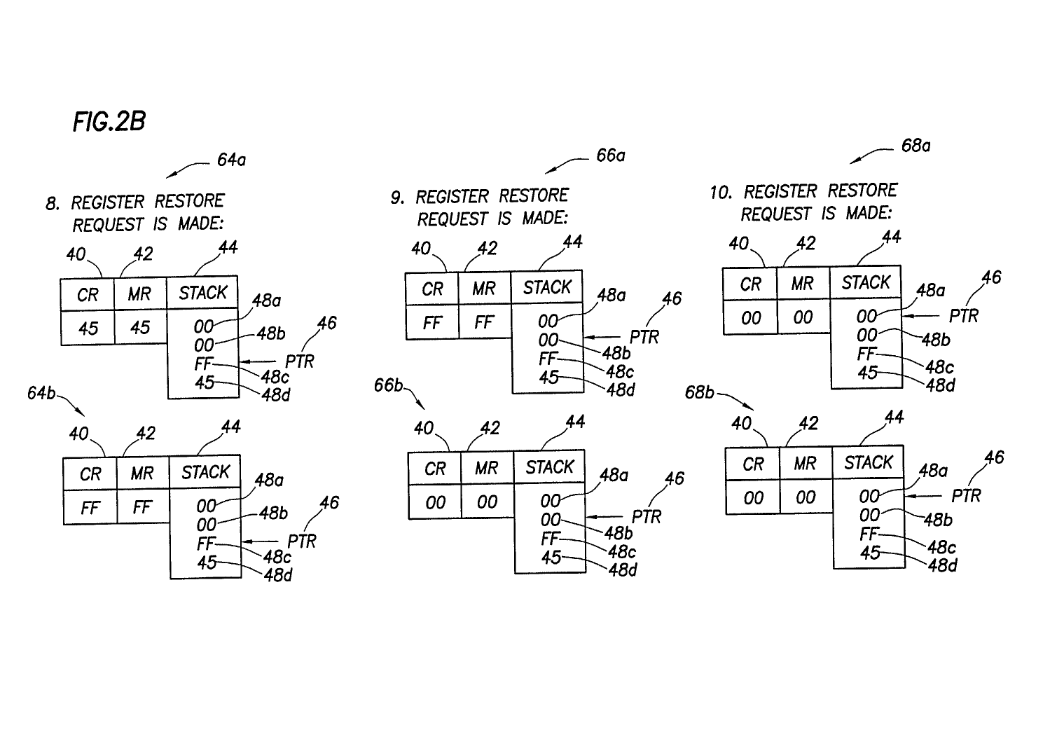

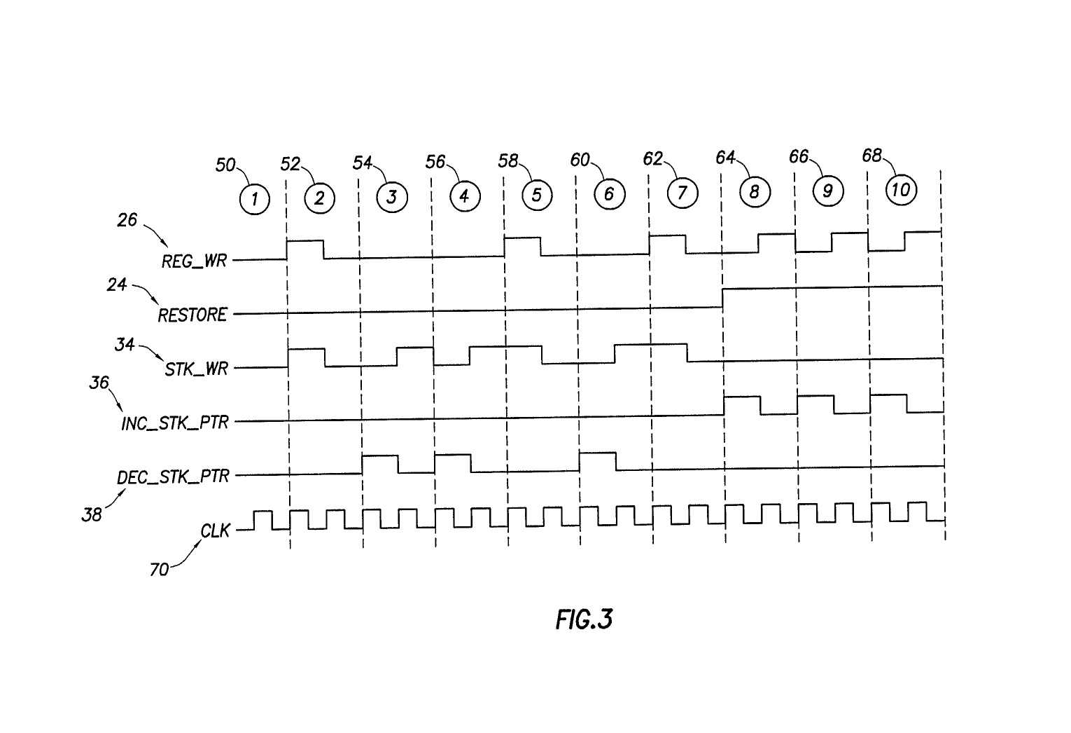

FIG. 2 depicts the contents of critical register 10 at 40, the contents of mirror register 30 at 42, and the contents of stack array 20 at 44, during various processor operations. Stack array contents 44 include entries or cells 48 for memory locations or values. Pointer 46 may be adjusted during various processor operations to point to an entry 48. FIG. 3 depicts the timing diagram for the control signals that are asserted during the processor operations depicted in FIG. 2. The timing diagram is divided into ten sections corresponding to the ten operations depicted in FIG. 2. The first timing element is the REG_WR control signal 26, followed by the RESTORE 24, STK_WR 34, INC_STK_PTR 36 and DEC_STK_PTR 38 control signals. At the bottom of the timing diagram is a CLK signal 70 to indicate the clock cycles at which the various control signals are asserted. The method of the present invention can be ascertained by referencing the operations shown in FIG. 2 with the timing diagram shown in FIG. 3. Note that the present invention is not limited to the particular sequence of operations shown in FIG. 2.

In FIG. 2, processor operation 50 depicts an initial state of critical register 10, mirror register 30 and stack array 20. The critical register contents 40, mirror register contents 42 and stack array contents 46 are in an unknown state and are therefore depicted by “XX” rather than a specific value. Pointer 46 initially points to the first entry 48a of stack array 20. As shown in FIG. 3, no control signals are being asserted in processor operation 50.

In FIG. 2, processor operation 52 corresponds to a register being accessed. As shown in FIG. 3, the REG_WR control signal 26 and STK_WR control signal 34 are both asserted. The assertion of REG_WR operates to write value contained on the write bus 16 to the critical register 10 and the mirror register 30. In this case, a value of “00” is written to both registers 10 and 30. The assertion of STK_WR operates to write the data carried on bus 32 to stack array 20 Because the data on bus 32 corresponds to the mirror register contents 40, the value of “00” is written to the entry 48 that is being pointed to by pointer 46. As a result, the value “00” is written to entry 48a of stack array contents 44. Note that stack pointer 46 is not adjusted during this operation. Alternatively, the in port of stack array 20 may be coupled to the read bus RD_DATA 12. In this configuration, the contents of critical register 10, rather than mirror register 30, are directly written to stack array 20 in response to the assertion of a STK_WR control signal 34. However, as discussed above, this configuration increases the loading burden on critical register 10 which adversely affects performance. Therefore, it is preferable to implement the configuration shown in FIG. 1, wherein the output bus 32 of mirror register 30, instead of critical register 10, is coupled to stack array 20.

The next processor operation is a register hold request 54. The hold request is operable to preserve the value that was held in critical register 10 before the event. For example, the event may be an interrupt or a jump operation to a subroutine that may manipulate the registers. The hold operation serves to hold or record the value to be preserved in stack array 20. Once the instruction is completed, critical register 10 may be restored to the value it held before the instruction was called or executed. As shown in FIG. 3, the STK_WR control signal 34 and a stack pointer signal are both asserted in response to the hold request. Depending on the configuration of stack array 20, the stack pointer signal may operate to either increment or decrement pointer 46 in response to a hold request. In this example, the DEC_STK_PTR control signal 38 is asserted in response to the hold request to decrement pointer 46. As a result, pointer 46 now points to entry 48b. The assertion of the STK_WR control signal 34 serves to write the mirror register contents 42 to the stack array entry 48 that is currently being pointed to by pointer 46. Consequently, the value of “00” is written to entry 48b. Note that the register write control signal REG_WR 26 is not asserted during a hold request.

The fourth operation 56 is a hold request without prior access. Note that the third operation 54 was a hold request in which the previous operation 52 was a register access. As shown in FIG. 3, the DEC_STK_PTR control signal 38 is first asserted in response to the hold request. This control signal moves pointer 46 down to entry 48c. Next, the STK_WR control signal is asserted. As a result, a value of “00” is written to entry 48c. Even though critical register 10 had not been accessed prior to this operation 56, it is preferable to adjust the pointer and write to stack array 20 during every hold operation. Otherwise, a later restore operation may restore an unknown or incorrect value to critical register 10. Adjusting pointer 46 and writing to stack array 20 ensures that the processor will be able to restore the correct sequence of values. For example, the current instruction that is being executed may not have accessed the critical register 10 and therefore, the critical register 10 would not have received a write operation.

The fifth operation 58, shown in FIG. 2, is a register access operation. As with the second operation 52, both the REG_WR control signal 26 and the STK_WR control signal 34 are asserted. In this case, the data currently carried on write data bus 16 corresponds to a value of “FF.” As a result, the value of “FF” is written to both registers 10 and 30 as a result of the assertion of the REG_WR control signal 26. In addition, the STK_WR control signal 34 causes the “FF” memory location to be written to entry 48c. As discussed above, pointer 46 is not adjusted during a register write operation.

The next operation 60 shown in FIG. 2 is a register hold request. As shown in FIG. 3, the DEC_STK control signal 38 is first asserted. This signal moves pointer 46 down to entry 48d. Next, the STK_WR signal 34 is asserted. As a result, the current mirror register entry 42, which is currently the “FF” value, is written to entry 48d.

The seventh operation 62 is a register access operation. Because this is a register access operation, both the REG_WR control signal 26 and the STK_WR control signal 34 will be asserted. In this case, the data currently on write bus 16 corresponds to a value of “45.” Thus, when controls signals 26 and 36 are asserted, the value of “45” is written to both registers 10 and 30, and to entry 48d of stack array contents 44.

The next operation 64 in the example presented in FIG. 2 is a restore operation. The restore operation is performed in order to reinstate the previous value in stack array 20 to critical register 10 and mirror register 30. Thus, the restore operation in conjunction with the increment stack pointer “INC_STK_PTR” and the register write “REG_WR” operations serve to recover the value previously held in the register after a given operation has been executed. As shown in FIG. 3, the RESTORE control signal 24 and the INC_STK_PTR control signal 36 are both initially asserted. The RESTORE control signal 24 is operable to cause mux 14 to transfer data to bus 18 from bus 22 instead of write bus 16. As a result, bus 18 will carry data from the output of stack array 20. As discussed above, the INC_STK_PTR control signal 36 increments pointer 46. As shown in 64a, pointer 46 moves up from entry 48d to entry 48c. As shown in FIG. 3, the RESTORE control signal 24 continues to be asserted and now the REG_WR control signal 26 is asserted. Note that the REG_WR control signal 26 is asserted after pointer 46 is adjusted. Because the RESTORE control signal 24 is still asserted, the REG_WR control signal 26 causes the currently pointed to entry 48 of stack array contents 44 to be written to the registers 10 and 30. Thus, the contents of entry 48c are written to both the critical register 10 and the mirror register 30. As a result, a value of “FF” is written to register contents 40 and 42.

The last two operations shown in FIG. 2 demonstrate the result of two more restore requests. The ninth operation 66 is another restore operation. Initially the RESTORE control signal 24 and INC_STK_PTR control signal are asserted. As a result, pointer 46 is moved up to entry 48b. Next, while the RESTORE control signal 24 is still being asserted, the REG_WR control signal 26 is asserted. As discussed above, the assertion of the register write signal 26 causes value that is stored in the entry 48 pointed to by pointer 46 to be written to registers 10 and 30. In this case, the value “00” is stored in entry 48b and is therefore written to registers 10 and 30. The tenth operation 68 is another restore operation. In a manner similar to the restore operations previously described, the pointer 46 is moved to the top entry 48 in stack array 20 and the value “00” is written to registers 10 and 30.

The mirror stack has several characteristics that differentiate it from the stacks used in the prior art. First, the mirror stack is associated with a specific register or memory locations. Values to be read from the mirror stack go to a predetermined destination. Second, unlike conventional stacks, the mirror stack pointer is adjusted during “hold” and read operations and not during register write operations. Finally, in the preferred embodiment of the present invention, the mirror stack and the specific register to which the mirror stack is associated should be isolated from any common bus in order to allow simultaneous updates within a single CPU cycle of the system that employs more than one mirror stack. It is instructive to note that through the use of a mirroring register and multiplexer, the loading on the read and the write ports are identical to that of a register without a mirroring stack. This allows the present invention to be utilized in applications that cannot normally include a mirror stack because of fears that a prior art mirror stack implementation would disrupt certain processes.

Mirror stacks can also be used to enable fast argument passing during subroutine calls. In that case, the user program will require access to the mirror stack in some manner in order to return the results of the call. However, this requirement is not required in all embodiments of the present invention. In the case of interrupts, it does not make sense to pass arguments to an interrupt service routine or to return results from an interrupt service routine since the state of the processor (during an interrupt) is typically not deterministic.

The mirror stack of the present invention is distinguished from the prior art in other features and operations. For instance, in a conventional prior art stack, the stack pointer is adjusted during reads and writes to the stack. However, a mirror stack pointer of the present invention is adjusted during saves and reads from the mirror stack, but is never modified during writes to a register because the mirror stack may be written to multiple times without the need to adjust the mirror stack pointer. Unlike the prior art stacks, the mirror stack of the present invention is tied to a specific register, typically a critical register such as the Program Counter. Moreover, the mirror stack introduces a new type of stack operation called “HOLD” that is not found in traditional stacks.

In summary, the present invention provides one or more M-stacks that are, individually, tied to any number of critical registers—one M-stack per critical register. The critical register can be a standard register, or a memory location that is used akin to a register. Any writes to the specific critical register are also written to the M-stack's currently pointed to location. The interface between the critical register and the M-stack must be isolated from other busses so that a transfer can take place between the M-stack and the critical register simultaneously and independently from other busses or other M-stacks. Finally, the uniqueness of the M-stack requires the introduction of a new stack operation: “HOLD.” In a prior art stack, the stack pointer gets adjusted during both “read” and “write” operations. In contrast, the pointer for an M-stack is adjusted only during “read” and “hold” operations. During “write” operations to the critical register, the M-stack pointer is not adjusted.

The present invention, therefore, is well adapted to carry out the objects and attain both the ends and the advantages mentioned, as well as other benefits inherent therein. While the present invention has been depicted, described, and is defined by reference to particular preferred embodiments of the invention, such references do not imply a limitation on the invention, and no such limitation is to be inferred. The invention is capable of considerable modification, alternation, alteration, and equivalents in form and/or function, as will occur to those of ordinary skill in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A microprocessor architecture comprising:
a write bus operable to transmit data;
at least one stack array, wherein the stack array is operable to store a plurality of values;
at least one multiplexor, wherein the multiplexor is operable to receive data from a stack array and the write bus, and output the data from either the stack array or the write bus;
at least one register, wherein the register is coupled to the multiplexor, and is operable to receive data from the multiplexor; and
at least one mirror register, wherein each mirror register is operable to receive data from a multiplexor, and wherein each mirror register is associated with a register such that data written to the register will also be written to the mirror register.

2. The microprocessor architecture of claim 1, wherein each mirror register further comprises an output, wherein the output is coupled to the stack array such that the mirror register is operable to write a value to a stack array.

3. The microprocessor architecture of claim 1,
wherein the register comprises an output; and
further comprising a read bus operable to transmit data, wherein the output of the register is coupled to the read bus such that the register is operable to transmit data through the read bus.

4. The microprocessor architecture of claim 3, wherein the output of the register is not coupled to a stack array.

5. The microprocessor architecture of claim 3, wherein the output of the register is coupled to a stack array such that the register is operable to write a value to the stack array.

6. The microprocessor architecture of claim 1, wherein the register is a program counter.

7. The microprocessor architecture of claim 1, wherein the register is a status register.

8. The microprocessor architecture of claim 1, wherein the multiplexor is operable to receive a restore signal, such that the multiplexor will output the data from write bus until the multiplexor receives the restore signal, in which case, the multiplexor will output data from the stack array while the restore signal is asserted.

9. The microprocessor architecture of claim 1, wherein a write port into said stack array has a load equivalent to the load of a single register on said write bus.

10. The microprocessor architecture of claim 1, wherein said architecture further comprising a read bus and a read port into said stack array.

11. The microprocessor architecture of claim 10, wherein said write port has a load equivalent to the load of a single register on said read bus.

12. A method for implementing a mirrored stack, said method comprising the steps of:
(a) providing at least one stack array, wherein the stack array comprises a plurality of entries, wherein each entry is operable to store a value;
(b) providing a stack array pointer operable to point to an entry in the stack array;
(c) providing a register operable to store a value;
(d) providing a mirror register operable to store a value, wherein the mirror register is associated with the register such that any value written to the register will also be written to the mirror register;
(e) writing a value to be held in a first entry of the stack array;
(f) receiving a hold request;
(g) adjusting the stack array pointer to point to a second entry of the stack array;
(h) writing the value to be held to the second entry of the stack array;
(i) receiving a restore request;
(j) adjusting the pointer to point to the first entry; and
(k) writing the value to be held from the first entry of the stack array to both the register and the mirror register.

13. The method of claim 12, wherein the mirror register writes the value to be held to the stack array in step (e).

14. The method of claim 12, wherein the register writes the value to be held to the stack array in step (e).

15. The method of claim 12, wherein the mirror register writes the value to be held to the stack array in step (h).

16. The method of claim 12, wherein the register writes the value to be held to the stack array in step (h).
